(19) United States
(12) Patent Application Publication
(10) Pub. No.: US 2016/0016471 A1
(43) Pub. Date: Jan. 21, 2016

(54) IN-VEHICLE APPARATUS

(71) Applicant: Alpine Electronics, Inc., Tokyo (JP)

(72) Inventor: Noboru Yamazaki, Iwaki (JP)

(21) Appl. No.: 14/793,250

(22) Filed: Jul. 7, 2015

(30) Foreign Application Priority Data
Jul. 18, 2014 (JP) 2014-147376

(51) Int. Cl. B60K 35/00; G06F 3/048; G06F 17/30

(52) U.S. Cl. CPC B60K 35/00; G06F 17/30241; G06F 17/3087; G06F 3/048; B60K 2350/1056; G06F 2216/03; G06F 2216/01

(57) ABSTRACT

An in-vehicle apparatus includes a content item searcher configured to search for a content item in accordance with an input search criterion; a content item list generator configured to generate a content item list including the content item searched for by the content item searcher in a form of a string; and a display controller configured to display the content item list in a list display region of a display section. The display controller is configured to change a width of the list display region in an arrangement direction of the string in accordance with a length of the string of the content item in the content item list in the arrangement direction of the string.

### RELATED APPLICATIONS

The present application claims priority to Japanese Patent Application Serial Number 2014-147376, filed Jul. 18, 2014, the entirety of which is hereby incorporated by reference.

### BACKGROUND OF THE INVENTION

1. Field of the Invention

The present invention relates to an in-vehicle apparatus which displays, as a list of contents, a search result matching an input search criterion.

2. Description of the Related Art

An in-vehicle apparatus such as a car navigation apparatus employs a content search method (such as a POI search method) that searches for a name of a destination facility or a track to be played. The result is displayed on two sections of a screen so that both of a list of a search result and an image or the like relating to the list are displayed for user convenience. For example, when a name of a hotel to which the vehicle is heading is input and searched for, two images are displayed side by side: one is a list of hotels corresponding to the input name and the other is a map indicating the position of the hotel at the top of the list or the hotel selected on the screen.

In such a list, since a search result such as a facility name often includes a product name and a proper noun (e.g., ABCGREEN-INN ABINGDOM), the result tends to be a relatively long string to be displayed on a single row. Sometimes, a facility name or the like (i.e., a search result) can be only partially displayed on a single row in a list display region of a screen. In a case where a proper noun does not need to be searched for, for example, when “convenience store” is searched for, a list, at the top of which is the nearest convenience store, and a map illustrating a location of the convenience store are displayed on the screen. In such a case, even if the proper noun is only partially displayed because it is too long for a single row in the list, a problem will not often occur provided that the facility whose name is at the top of the list is the nearest one from the current position of the vehicle and its position is displayed on the map.

However, when a user searches for a proper noun at a specific location, the name being searched for is not always displayed at the top of the list. If there is more than one facility corresponding to the search criterion and the names of facilities are displayed only partially in each row, it would be difficult for a user to select the desired item. For example, as illustrated in FIG. 7, when a facility name includes a relatively long string, not all the characters of the name are displayed on a single row on the screen. Further, since only the first few characters of the names are displayed in the list, different names are sometimes displayed identically (for example, “ARKLTON INN-ABILENE” and “ARKLTON INN-ABINGDON” have “ARKLTON INN-ABI” in common in FIG. 7). In such a case, a user cannot select the correct item. When the user scrolls in the horizontal direction, they can read the whole part of the name having a long string; however, if they are required to do so each time a long facility name is displayed, it is laborious, not user-friendly, and not useful. Regarding a facility name or the like which includes a product name and a proper noun, the product name and the proper noun could be divided and tiered so that the whole name is displayed on a single row; however, this method requires a conversion process in a database before transmission of data, and such a process is difficult to be executed before text data or the like is transmitted from a server, as in a case of a POI search method or the like. Alternatively, a part of a string which is common in neighboring rows, such as a product name, could be omitted from the display; however, this method requires a complex process including a step of detecting identical data, and recognition of data would be difficult for the user due to the omission from the display.

In order to provide a solution to such a problem in which names of search results are displayed only partially in a list display region, an in-vehicle apparatus in which a method for displaying a list is modified has been proposed (see, for example, Japanese Unexamined Patent Application Publication No. 2012-94037 and Japanese Unexamined Patent Application Publication No. 2005-55261).

In Japanese Unexamined Patent Application Publication No. 2012-94037, a part of a string that is common to at least two rows in the list is displayed in a smaller font than others so that the length of a string to be displayed on a single row is reduced. In Japanese Unexamined Patent Application Publication No. 2005-55261, a first part of the facility names which is common to a plurality of facility names is displayed in a first display region, and other parts of the names are displayed in a second display region so that the length of the string to be displayed on a single row is reduced.

In Japanese Unexamined Patent Application Publication No. 2012-94037 and Japanese Unexamined Patent Application Publication No. 2005-55261, a part common to a plurality of rows is reduced in size or displayed in a separate display region, so that the length of a string to be displayed on a single row is reduced to display the whole name. However, when the user tries to read the facility name while driving a vehicle, the names cannot be read at a glance; therefore, high usability has not been achieved.

### SUMMARY OF THE INVENTION

An object of the present invention is to provide an in-vehicle apparatus in which a list of contents including a relatively long string can be appropriately displayed on a screen.

An in-vehicle apparatus according to one aspect of the present invention includes a content item searcher that searches for a content item in accordance with an input search criterion; a content item list generator that generates a content item list including the content item searched for by the content item searcher in a form of a string; and a display controller that displays the content item list in a list display region of a display section. The display controller changes a width of the list display region in an arrangement direction of the string in accordance with a length of the string of the content item in the content item list in the arrangement direction of the string.

In such a structure, the width of the list display region in the arrangement direction of the string is changed by the display controller in accordance with the length of the content item in the content item list in the arrangement direction of the string. When the string of the content item is long, the width of the list display region in the arrangement direction of the string is increased, whereby the content item can be easily read even when the string thereof is long. For example, as described above, a content item such as facility information in a POI search, musical information of in a musical search, broadcast program information in a broadcaster search, and telephone number information in a telephone number search, or the like can be easily read and selected.

In the above-described in-vehicle apparatus, the display controller can include an image converter configured to convert the string of the content item into an image; an arrangement-direction length calculator configured to calculate a length of the content item in the arrangement direction of the string using the number of dots in the image in the arrangement direction of the string; a comparison determiner configured to compare a standard width of the list display region in the arrangement direction of the string and the length of the content item in the arrangement direction of the string that is calculated by the arrangement-direction length calculator and determines whether or not the calculated length in the arrangement direction of the string is longer than the standard width; and a region adjuster configured to increase a width of the list display region in the arrangement direction of the string when the calculated length in the arrangement direction of the string is longer than the standard width.

In such a structure, the string is converted into the image and the length in the arrangement direction of the string is calculated using the number of dots in the image. When the calculated length in the arrangement direction of the string is longer than the standard width of the list display region, the width of the list display region in the arrangement direction of the string is increased, whereby the content item can be easily read even when the string thereof is long. Note that the standard width is a length defined in advance as a standard value of the width of the list display region in the arrangement direction of the string.

In the above-described in-vehicle apparatus, the region adjuster can reduce the width of the list display region in the arrangement direction of the string when the calculated length in the arrangement direction of the string is shorter than the standard width.

In such a structure, when the calculated length in the arrangement direction of the string is shorter than the standard width, the width of the list display region in the arrangement direction of the string is reduced, whereby other related information can be displayed in the display section to increase user-friendliness.

In the above-described in-vehicle apparatus, the region adjuster can increase or reduce the width of the list display region in the arrangement direction of the string within a range of a predetermined maximum width and minimum width.

In such a structure where the width of the list display region in the arrangement direction of the string can be increased or reduced within the range of the predetermined maximum width and minimum width, the width of the list display region can be set in accordance with the length of string of the content item. The predetermined maximum width and minimum width are set so that both of a display region of other related information and a display region of the list display region can perform appropriate display with such a limitation.

In the above-described in-vehicle apparatus, the image converter can convert the string of the content item into a bitmap image.

In such a structure, the number of dots in the arrangement direction of the string can be calculated using the bitmap image converted from the string of the content item, whereby the length of the content item in the arrangement direction of the string can be easily calculated.

Another in-vehicle apparatus may include a content item searcher configured to search for a content item in accordance with an input search criterion; a content item list generator configured to generate a content item list including the content item searched for by the content item searcher in a form of a string; and a display controller configured to display the content item list in a first display region and configured to display information related to the content item list in a second display region of a display section. The display controller is configured to change a width of the first display region and a width of the second display region in an arrangement direction of the string in accordance with a length of the string of the content item in the content item list in the arrangement direction of the string.

In such a structure, the widths of the first display region and the second display region in the arrangement direction of the string are changed in accordance with the length of the content item in the content item list in the arrangement direction of the string. When the string of the content item is long, the width of the first display region in the arrangement direction of the string can be increased, whereby the content item can be easily read even when the string thereof is long.

In the above-described in-vehicle apparatus, the first display region and the second display region can be arranged in the arrangement direction of the string in the display section.

In such a structure where the first display region and the second display region are arranged in the arrangement direction of the string in the display section, the widths of the first display region and the second display region in the arrangement direction of the string can be easily changed.

In the above-described in-vehicle apparatus, the display controller can display an image which is related to a content item at a top of or selected in the content item list in the first display region as the related information in the second display region.

In such a structure where the image, which is related to the content item at the top of or selected in the content item list in the first display region, is displayed as the related information in the second display region, the change in the width of the first display region and the second display region in the arrangement direction of the string can lead to improvement in user-friendliness.

### BRIEF DESCRIPTION OF THE DRAWINGS

FIG. 1 is a block diagram illustrating a configuration of an in-vehicle device.

FIG. 2 is a flowchart illustrating process steps in a processing unit in the in-vehicle device illustrated in FIG. 1.

FIG. 3 illustrates a list including a name of a content (a facility name), which is a search result, and the number of dots in a bitmap image of the string of the name of the content.

FIGS. 4A and 4B are each a schematic view illustrating a content list (facilities names) and a map related thereto which are displayed in a display section in an in-vehicle apparatus.

FIG. 5 is a schematic view illustrating a content list (facilities names) and a map related thereto which are to be displayed in a display section in an in-vehicle apparatus.

FIGS. 6A and 6B are each a schematic view illustrating a content list (a track name list) and an image related thereto (a cover image) which are displayed in a display section in an in-vehicle apparatus.

FIG. 7 is a schematic view illustrating a content list (facility names) and a map related thereto which are displayed in a display section in a conventional in-vehicle apparatus.

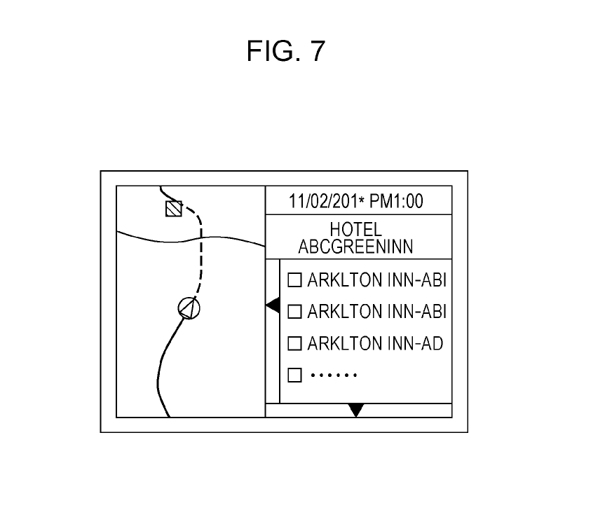

### DETAILED DESCRIPTION OF THE DRAWINGS

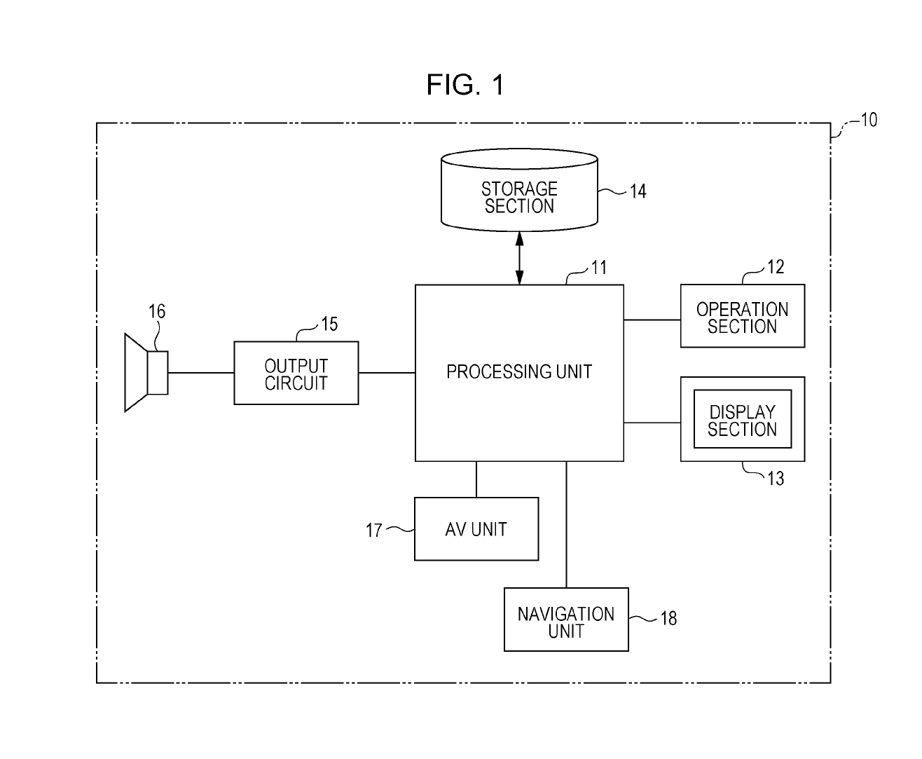

A configuration of an in-vehicle apparatus is illustrated in FIG. 1. In FIG. 1, an in-vehicle apparatus 10 includes a processing unit 11 which includes a computing unit (including components such as a CPU, a RAM, a ROM, and a bus connecting these components). The processing unit 11 is connected to an AV unit 17 to play musical sources and video sources (such as CDs and DVDs) and to a navigation unit 18 which can be used to navigate a vehicle in which the in-vehicle apparatus 10 is mounted. The processing unit 11 is also connected to an output circuit 15 which is connected to a speaker 16. Audio signals processed in the AV unit 17 and the navigation unit 18 can be output from the speaker 16 via the output circuit 15. In addition, the processing unit 11 is connected to a storage section 14 (such as a hard disk or a flash memory) which can store various kinds of information such as music or map information which is used by the AV unit 17 and the navigation unit 18, a display section 13 including an LCD or the like which displays videos or the like relating to various processes, and an operation section 12 which is a touch screen on the display section 13 through which instructions needed for the various processes can be input.

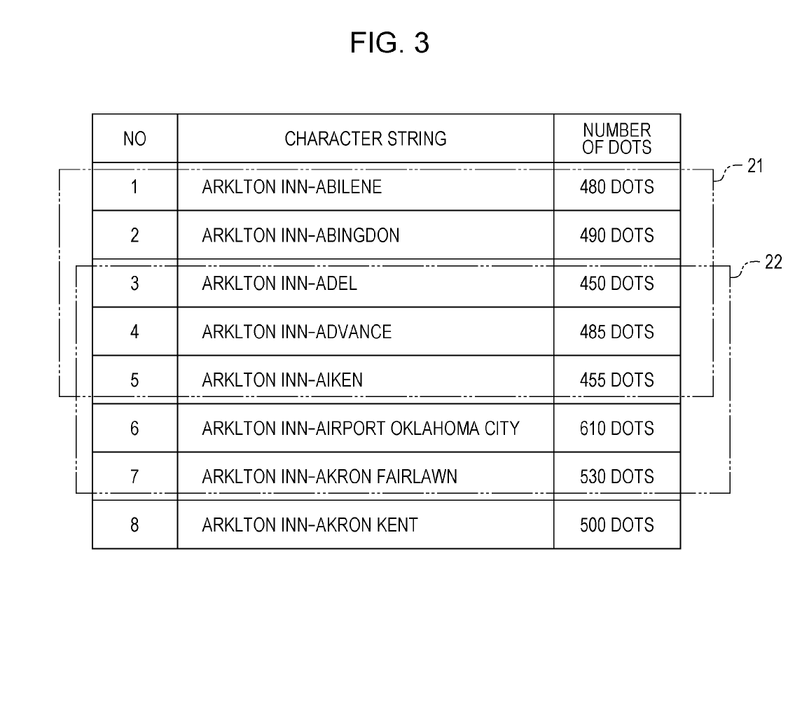

With reference to FIG. 3 illustrating a list that includes facility data which is a result of a POI search (a content search) and includes the number of dots in an image of a string of the facility name in the list, calculation of the length of the string of a facility name in an arrangement direction of the string (i.e., a direction in which the characters in the string are arranged) will be described.

The list in FIG. 3 includes facility names of the search result and the number of dots which is obtained via a bitmap image of each of the strings. FIG. 3 illustrates a part of a search result with search terms “ARKLTON” and “HOTEL”, which are input with the operation section 12 in the in-vehicle device 10. The facility names obtained through the search each includes a general name “ARKLTON INN” and a proper noun (e.g., “ABILENE”) with a hyphen “-” therebetween.

As illustrated in FIG. 3, the facility names are displayed in the form of a string, which is a combination of characters. The number of dots corresponds to the number of dots in a bitmap (BMP) image to which each of the displayed strings is converted. As illustrated in FIG. 3, the first facility name in the list is “ARKLTON INN-ABILENE” which has 480 dots, while a facility name with a larger number of characters, for example, “ARKLTON INN-AIRPORT OKLAHOMA CITY” in the sixth line has 610 dots.

In this embodiment, for a region displaying the list of facility names, a standard width used for reference is predetermined. The standard width here is 500 dots. In a first part of the search result, which is a first display item 21 (indicated by a chain line in FIG. 3), each of the first to fifth facility names has 500 dots or less and is less than the standard width. Therefore, when the first display item 21 is displayed, all characters of the facility names can be displayed. Then, the display is scrolled to display a second display item 22 (also indicated by a chain line in FIG. 3). Here, the third to seventh facility names are displayed. As described above, the sixth facility name “ARKLTON INN-AIRPORT OKLAHOMA CITY” has 610 dots and the seventh facility name “ARKLTON INN-AKRON FAIRLAWN” has 530 dots; therefore, if the region to display the list remains with the standard width of 500 dots, some of the characters in the facility names will not be displayed. In this embodiment, in order to solve such a problem, a width of a list display region in the arrangement direction of the string is changed in accordance with the length of the string of the facility name. In other words, when the length of the string of the content in the arrangement direction of the string is longer than the standard width, the width of the list display region in the arrangement direction of the string is changed to be longer than the standard width, so that the user can easily read the facility names in the displayed list and select an item.

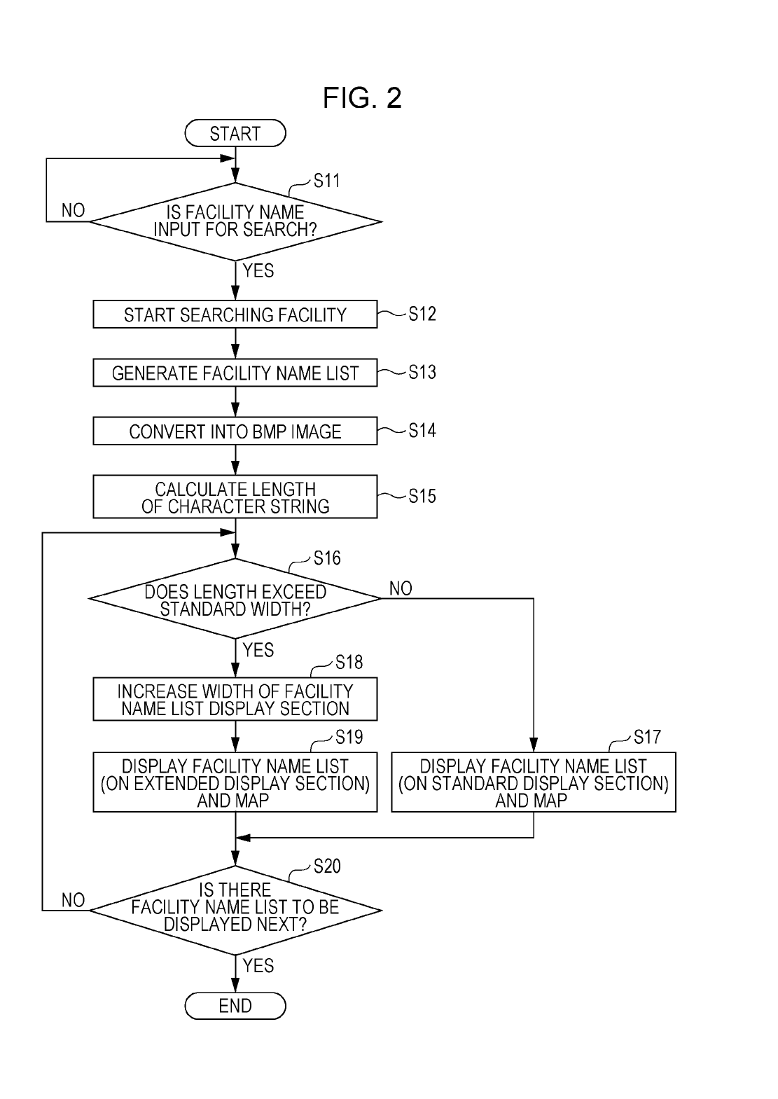

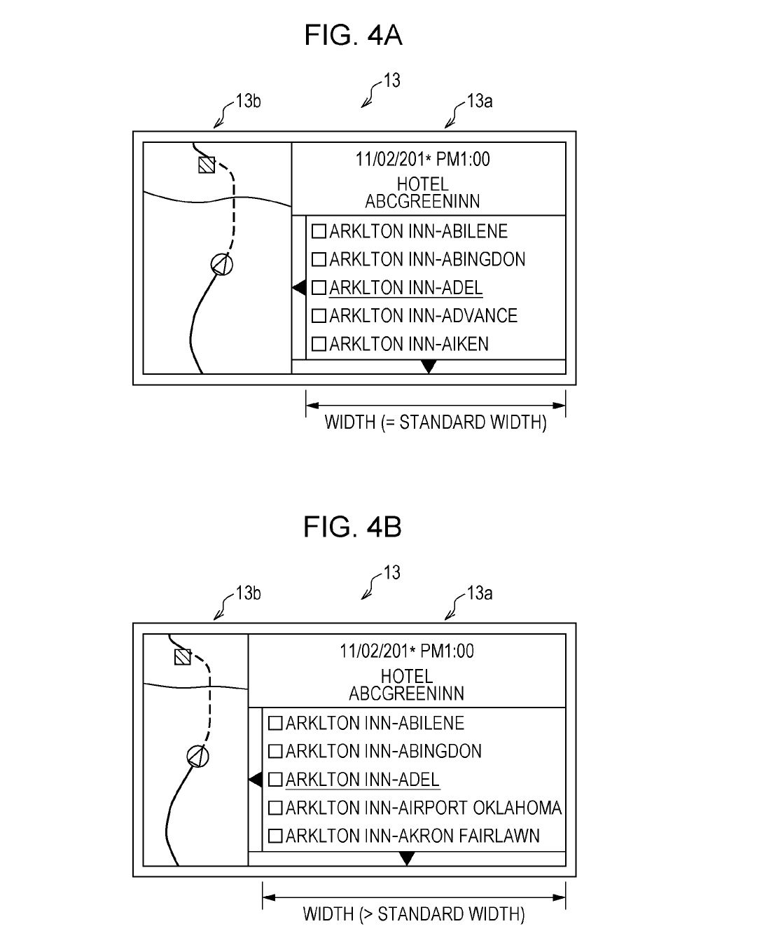

A process in the in-vehicle apparatus 10 according to an embodiment of the present invention is described with reference to FIG. 2 illustrating steps of the process. Note that in the description of these steps, as well as in FIG. 1 illustrating a configuration, FIGS. 4 to 6, which are schematic diagrams of the display section, and FIG. 3 illustrating a list of facility names, etc. are referenced as needed.

When a keyword such as a facility name to be searched for is input using the operation section 12 (“YES” in S11), the processing unit 11 starts searching for a facility related to the keyword (S12). When a keyword such as a facility name is not input (“NO” in S11), a function previously set by the user (such as a navigation function) is not interrupted. In this embodiment, the keywords are “ARKLTON” and “HOTEL”. The processing unit searches for facility information related to the keywords (S12: content searcher).

Then, the processing unit 11 generates a facility name list which is a list of contents where facility data searched for with the above keywords is included in the form of a string (S13: content list generator). The generated facility name list includes a part to display Nos. (numbers) and a part to display strings as illustrated in FIG. 3. As illustrated by a string in the facility name list in FIG. 3, a facility name is a combination of a general name “ARKLTON INN” and a respective proper noun with a hyphen therebetween. The facility names are arranged in alphabetical order.

Next, the processing unit 11 converts the string of the facility name in the facility name list into a bitmap image (S14: image converter). Specifically, the facility name including characters is displayed as the string in the facility name list, and the string is converted into a bitmap image. The conversion into a bitmap image is performed to measure the length of the string of the facility name in the arrangement direction of the string by using the number of dots in the string. For calculating an accurate number of dots, a bitmap image is optimal.

Next, the processing unit 11 calculates the number of dots in the bitmap image which is converted from the string of the facility name as described above to obtain the length of the string (S15: calculator). The length of the string may be indicated by using a length unit or by using the number of dots.

Next, the processing unit 11 determines whether or not the number of dots in the bitmap image converted from the string of the facility name in the facility name list exceeds the previously determined number of dots in the standard width, which is a width of the list display region in the arrangement direction of the string (S16: comparison determiner). Specifically, the number of dots in the bitmap image of the string of the facility name included in the facility name list in the list display region and the number of dots of the standard width are compared to determine whether or not the former exceeds the latter. For example, when a display item is the first display item 21 illustrated in FIG. 3, each of the numbers of dots in the bitmap images of the strings in the first display item 21 (the first facility name has 480 dots, the second facility name has 490 dots, the third facility name has 450 dots, the fourth facility name has 485 dots, and the fifth facility name has 455 dots) and the standard width (500 dots) are compared to determine whether or not the former exceeds the latter.

When the number of dots in the bitmap image of the string to be displayed does not exceed the predetermined standard width (500 dots) (“NO” in S16), the width of the list display region does not change from the predetermined standard width, and the processing unit 11 displays display items (facility names). As illustrated in FIG. 4A, a facility name list display section 13a (a first display region) with the standard width in the display section 13 displays the whole facility names in the first display item 21 in FIG. 3, without omitting any of the characters (S17: display controller). In a map display section 13b adjacent to the facility name list display section 13a (in the arrangement direction of the string of the facility name), a map illustrating a location of a facility selected in the facility name list display section 13a (underlined in the drawing) is displayed. Note that the current location of the vehicle is indicated by a symbol at the center of the map display section 13b.

In a case where the number of dots in the bitmap image of the string of the facility name to be displayed exceeds the predetermined standard width (500 dots) (“YES” in S16), the processing unit 11 increases the width of the list display region (the facility name list display section 13a) from the standard width. Note that the width of the map display section 13b needs to have at least a predetermined value so that display of the map is not deteriorated; therefore, the width of the list display region (the facility name list display section 13a) is increased with a limitation of the maximum width (for example, 550 dots) (S18: display region adjuster). The second display item 22 in FIG. 3 is displayed on the facility name list display section 13a as illustrated in FIG. 4B where the facility name list display section 13a (the first display region) is wider (i.e., 550 dots) than the standard width (S19: display controller). Here, as illustrated in FIG. 4B, although the width of the facility name list display section 13a is increased, due to the maximum width limitation, with regard to the sixth facility name (610 dots) included in the second display item 22 in FIG. 3, last few characters of the name, “CITY”, is not displayed while the all characters of the string of the seventh facility name (530 dots) is displayed. However, when the facility name list display section 13a increases from the standard width, the sixth facility name becomes easier to read. At the same time, since the width of the map display section 13b is kept longer than or equal to the predetermined width, display of the map is not deteriorated and usability is improved. Note that, if the list includes a very small number of contents which have a longer string than others, like the sixth item, the maximum width may be set to be larger (for example, to 630 dots) if a user does not mind the width of the image being temporary small. In such a manner, the whole string of the sixth item can be displayed and the maximum width can be changed by a user operation.

If there is a facility name list to be displayed next and the user scrolls the display (“NO” in S20), the processing unit 11 again determines whether or not the length of a string in the facility name list exceeds the standard width (S16: comparison determiner). When the length of a string exceeds the standard width, the width of the facility name list display section 13a is increased (S18) to display the facility name list (S19). When the length of a string in the facility name list does not exceed the standard width, the facility name list is displayed in the facility name list display section 13a with the standard width (S17). When all of the facility names in the list have been displayed or the user cancels the display operation, the process ends (“YES” in S20).

As described above, when the length of the facility name in the arrangement direction of the string, which is obtained as a result of a content search, exceeds the standard width of the facility name list display section 13a (the list display region), the width of the facility name list display section 13a is increased to display the facility name list; therefore, a user can easily read the search result even when the string of the result is long.

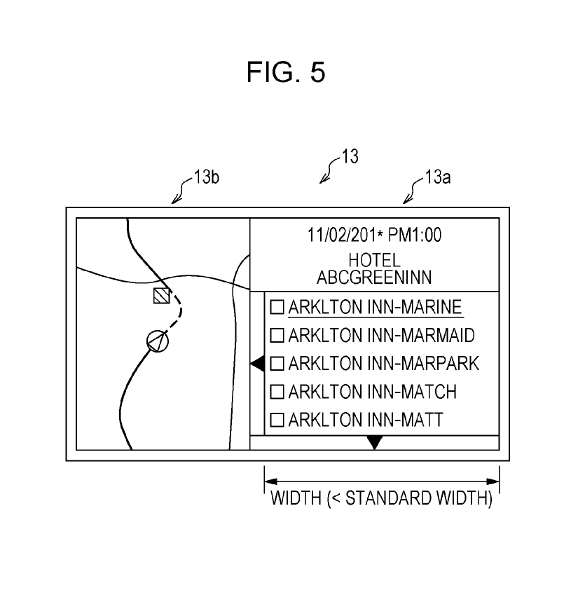

A further embodiment is described below with reference to FIG. 5. In this embodiment, when the length of the facility name in the arrangement direction of the string in the facility name list is shorter than the standard width of the facility name list display section 13a (the list display region), the width of the facility name list display section 13a is reduced (with a minimum width as the lower limit) to display the facility name list. When the width of the facility name list display section 13a is reduced, related information can be displayed on a larger display section. This process is added to the above-described embodiment; the processing unit 11 compares the length of the string in the arrangement direction of the string in the facility name list and the standard width of the facility name list display section 13a, and when the former is longer than the latter, the width of the facility name list display section 13a is increased from the standard width, whereas, when the former is shorter than the latter, the width of the facility name list display section 13a is reduced from the standard width as described above, such that an in-vehicle apparatus with a user-friendly graphical user interface can be provided.

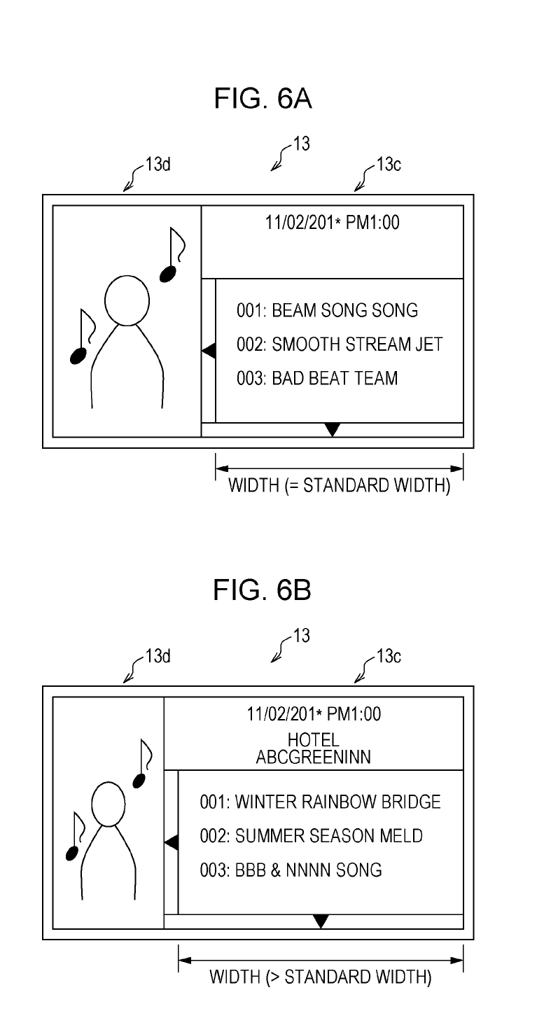

Next, another embodiment of the present invention is described with reference to FIGS. 6A and 6B. As illustrated in FIGS. 6A and 6B, the screen of the display section 13 is divided into a track name list display section 13c (a first display region) and a cover image display section 13d. In the in-vehicle apparatus 10, when a name of an artist A is input by using the operation section 12 for a content search, a track name list related to the artist A is displayed on the track name list display section 13c and a cover image of the artist A is displayed in the cover image display section 13d (see, FIG. 6A). Here, the width of the track name list display section 13c in the arrangement direction of the string is set at the standard width. When the length of a string in the track name list to be displayed is longer than the standard width, the string in the track name list is only partially displayed, which may make it difficult to select a track.

Such a problem can be solved as in a case of the above-described facility name list. Specifically, the length of the string in the track name list is calculated by using the number of dots in a bitmap image; when the number of dots exceeds the number corresponding to the predetermined standard width, as illustrated in FIG. 6B, the width of the track name list display section 13c (the list display region) is increased from the standard width. As in the above embodiment, the maximum width can be set. Note that the maximum width can be set in accordance with user preference. In such a manner, as in a case of the facility name list display, the width of the track name list display section can be adjusted in accordance with the length of the track name in the track name list in the arrangement direction of the string; therefore, when the string of the track name is long, the width of the track name list display section (the list display region) is changed, such that track names can be appropriately displayed and easily read by a user. Note that when the length of a string in the track name list is shorter than the standard width of the track name list display section 13c, the width of the track name list display section 13c can be reduced.

Although a case where a track name list and a cover image are displayed in the track name list display section 13c and the cover image display section 13d, respectively, has been described (see, FIGS. 6A and 6B), when a broadcast program or telephone number is searched for in a content search, a channel name list and an icon of a selected channel or a telephone number list and an photograph of a person whose telephone number is selected can be displayed in the list display section (the first display region) and a related image display section (a second display region), respectively. Here, as described above, in accordance with a comparison result of the length of an alphabetical (or numeric) string in the list and the standard width of the list display section, the width of the list display section is changed, such that a user can utilize a content search result more usefully and conveniently.

In an in-vehicle apparatus, when a string of a content is long, a width of a list display region in an arrangement direction of the string is changed, such that the content can be easily read. Therefore, an in-vehicle apparatus as described above is useful as an in-vehicle apparatus to display a list of content which is a result of a search operation based on an input search criterion.

It is intended that the foregoing detailed description be regarded as illustrative rather than limiting, and that it be understood that it is the following claims, including all equivalents, that are intended to define the spirit and scope of this invention.

What is claimed is:

1. An in-vehicle apparatus, comprising:
a content item searcher configured to search for a content item in accordance with an input search criterion;
a content item list generator configured to generate a content item list including the content item searched for by the content item searcher in a form of a string; and
a display controller configured to display the content item list in a list display region of a display section,
wherein the display controller is configured to change a width of the list display region in an arrangement direction of the string in accordance with a length of the string of the content item in the content item list in the arrangement direction of the string.

2. The in-vehicle apparatus according to claim 1, wherein the display controller includes:
an image converter configured to convert the string of the content item into an image,
an arrangement-direction length calculator configured to calculate a length of the content item in the arrangement direction of the string using the number of dots in the image in the arrangement direction of the string,
a comparison determiner configured to compare a standard width of the list display region in the arrangement direction of the string and the length of the content item in the arrangement direction of the string that is calculated by the arrangement-direction length calculator and configured to determine whether or not the calculated length in the arrangement direction of the string is longer than the standard width, and
a region adjuster configured to increase a width of the list display region in the arrangement direction of the string when the calculated length in the arrangement direction of the string is longer than the standard width.

3. The in-vehicle apparatus according to claim 2, wherein the region adjuster is configured to reduce the width of the list display region in the arrangement direction of the string when the calculated length in the arrangement direction of the string is shorter than the standard width.

4. The in-vehicle apparatus according to claim 3, wherein the region adjuster is configured to increase or reduce the width of the list display region in the arrangement direction of the string within a range of a predetermined maximum width and minimum width.

5. The in-vehicle apparatus according to claim 2, wherein the image converter is configured to convert the string of the content item into a bitmap image.

6. An in-vehicle apparatus, comprising:
a content item searcher configured to search for a content item in accordance with an input search criterion;
a content item list generator configured to generate a content item list including the content item searched for by the content item searcher in a form of a string; and
a display controller configured to display the content item list in a first display region and configured to display information related to the content item list in a second display region of a display section,
wherein the display controller is configured to change a width of the first display region and a width of the second display region in an arrangement direction of the string in accordance with a length of the string of the content item in the content item list in the arrangement direction of the string.

7. The in-vehicle apparatus according to claim 6, wherein the first display region and the second display region are arranged in the arrangement direction of the string in the display section.

8. The in-vehicle apparatus according to claim 6, wherein the display controller displays an image which is related to a content item at a top of or selected in the content item list in the first display region as the related information in the second display region.
